(19) United States
(12) Patent Application Publication
(10) Pub. No.: US 2008/0178268 A1
(43) Pub. Date: Jul. 24, 2008

(54) ELECTRONIC APPARATUS, CONTROL METHOD, AND COMPUTER PROGRAM PRODUCT

(75) Inventor: Itaru KODAIRA, Kanagawa (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/014,998

(22) Filed: Jan. 16, 2008

(30) Foreign Application Priority Data
Jan. 24, 2007 (JP) 2007-014016

(51) Int. Cl. G06F 15/16; G06F 21/20

(52) U.S. Cl. 726/4; 709/201

(57) ABSTRACT

A communicating unit performs a communication operation to a destination address designated by an address designating unit. A result displaying unit displays a result of an operation stored in a result storing unit in a readable manner. Upon the address designating unit designating the destination address, a control unit, with a plurality of inputs of the destination address, causes the communicating unit to perform the communication when the destination address is identical at each of the inputs, and causes the result storing unit to store therein a result of an address mismatch when the destination address is not identical at each of the inputs.

### CROSS-REFERENCE TO RELATED APPLICATIONS

The present application claims priority to and incorporates by reference the entire contents of Japanese priority document 2007-014016 filed in Japan on Jan. 24, 2007.

### BACKGROUND OF THE INVENTION

1. Field of the Invention

The present invention relates to an electronic apparatus such an as image forming apparatus (a digital multifunction product (MFP), a digital copier, a facsimile apparatus, a printer, etc.) and an image scanning apparatus (a scanner, etc) having a communication, a mail terminal, a telephone, and a computer, a method for controlling such an electronic apparatus, and a computer program product.

2. Description of the Related Art

In a facsimile apparatus for example, by designating an address by a telephone number, a facsimile can be sent to any recipient. When designating a wrong address that actually exists, a facsimile may be sent to a wrong recipient, causing confidential documents to be sent to a wrong recipient or information of a sender to be leaked. Thus, address input error may lead to a serious security problem.

The present applicant has previously proposed a facsimile apparatus that requires entry of the same number twice to send a facsimile and performs calling when a number entered for the first time matches a number entered for the second time, thereby preventing address input error (Japanese Patent Application No. 2005-359793).

Although such a facsimile apparatus can prevent sending error due to address input error, it has failed to reduce the address input error, because errors made in reentering addresses have not particularly been recorded. To fundamentally prevent such sending error due to address input error, a user should enter an address with the greatest care as a basic rule. With such a facsimile apparatus, however, a user may feel reassured assuming that the apparatus can check such address input error, and the user may tend to be less cautious in entering an address.

### SUMMARY OF THE INVENTION

It is an object of the present invention to at least partially solve the problems in the conventional technology.

According to an aspect of the present invention, there is provided an electronic apparatus including an address designating unit that designates a destination address; a communicating unit that performs a communication operation to the destination address designated by the address designating unit; a result storing unit that stores therein a result of an operation; a result displaying unit that displays the result, stored in the result storing unit in a readable manner; and a control unit that, upon the address designating unit designating the destination address, with a plurality of inputs of the destination address, causes the communicating unit to perform a communication to the destination address when the destination address is identical at each of the inputs, and causes the result storing unit to store therein a result of an address mismatch when the destination address is not identical at each of the inputs.

Furthermore, according to another aspect of the present invention, there is provided a method of controlling an electronic apparatus that performs a communication to a destination address that is designated in advance. The method includes causing a plurality of inputs of the destination address to be performed; and causing a communication to the destination address to be performed when the destination address is identical at each of the inputs, and causing a result of an address mismatch to be stored in a memory when the destination address is not identical at each of the inputs.

Moreover, according to still another aspect of the present invention, there is provided a computer program product including a computer-usable medium having computer-readable program codes embodied in the medium that when executed cause a computer to execute causing a plurality of inputs of the destination address to be performed; and causing a communication to the destination address to be performed when the destination address is identical at each of the inputs, and causing a result of an address mismatch to be stored in a memory when the destination address is not identical at each of the inputs.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration block diagram of an MFP according to an embodiment of the present invention;

FIG. 2 is a layout view of an operation display unit of the MFP shown in FIG. 1;

FIG. 3 is a screen flow diagram when a telephone number is entered twice using the operation display unit shown in FIG. 2;

FIG. 4 is a flowchart of a first example of a control process performed by a system control unit of the MFP shown in FIG. 1;

FIG. 5 is a screen flow diagram when a failure count of address entry is viewed using the operation display unit shown in FIG. 2;

FIG. 6 is a report notifying that the failure count of address entry has reached a certain count;

FIG. 7 depicts an electronic mail notifying the same as in FIG. 6;

FIG. 8 is a flowchart of a second example of control processes performed by the system control unit of the MFP shown in FIG. 1;

FIG. 9 is a screen flow diagram when operations for user authentication are performed using the operation display unit shown in FIG. 2;

FIG. 10 depicts a first example of a user management table stored and held in a parameter memory of the MFP shown in FIG. 1;

FIG. 11 depicts a second example of the user management table;

FIG. 12 is a flowchart of a third example of control processes performed by the system control unit of the MFP shown in FIG. 1;

FIG. 13 depicts a third example of the user management table stored and held in the parameter memory of the MFP shown in FIG. 1;

FIG. 14 is a flowchart of a fourth example of control processes performed by the system control unit of the MFP shown in FIG. 1;

FIG. 15 depicts a warning screen notifying that use of a fax is stopped and appearing on the operation display unit shown in FIG. 2;

FIG. 16 is a flowchart of a fifth example of control processes performed by the system control unit of the MFP shown in FIG. 1;

FIG. 17 depicts a warning screen notifying that the fax cannot be used and appearing on the operation display unit shown in FIG. 2;

FIG. 18 is a flowchart of a sixth example of control processes performed by the system control unit of the MFP shown in FIG. 1;

FIG. 19 depicts an address entry failure log adr_fail_log;

FIG. 20 is a flowchart of a seventh example of control processes performed by the system control unit of the MFP shown in FIG. 1;

FIG. 21 depicts a display screen that displays contents of address entry failures on the operation display unit shown in FIG. 2;

FIG. 22 depicts a phonebook table stored and held in the parameter memory of the MFP shown in FIG. 1;

FIG. 23 is a screen flow diagram when an address registered in a phonebook table is designated using the operation display unit shown in FIG. 2;

FIG. 24 is a screen flow diagram when an address is registered in the phonebook table in the same way as in FIG. 23;

FIG. 25 is a simplified flow screen diagram for recommending phonebook registration when address entry is failed;

FIG. 26 is a flowchart of an eighth example of control processes performed by the system control unit of the MFP shown in FIG. 1;

FIG. 27 is a screen flow diagram when an address is automatically registered in the phonebook table using the operation display unit shown in FIG. 2;

FIG. 28 is a flowchart of a ninth example of control processes performed by the system control unit of the MFP shown in FIG. 1; and

FIG. 29 depicts another arrangement of the address entry failure log adr_fail_log.

### DETAILED DESCRIPTION OF THE PREFERRED EMBODIMENTS

Exemplary embodiments of the present invention are explained in detail below with reference to the accompanying drawings. As an electronic apparatus, the embodiments describe an image forming apparatus, specifically a digital multifunction product (hereinafter, “MFP”) having functions of a copier, a facsimile (hereinafter, “fax”), and the like.

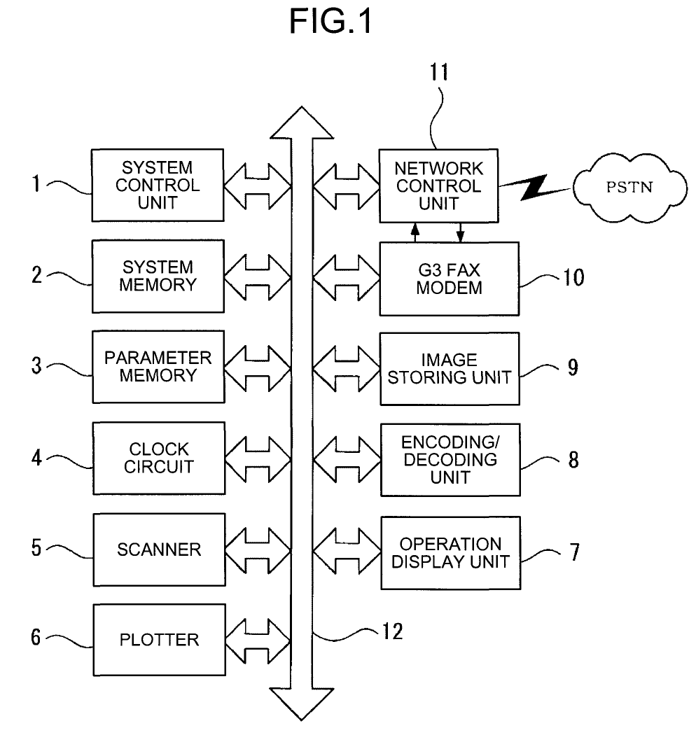

FIG. 1 is a configuration block diagram of an MFP according to an embodiment of the present invention.

The MFP has a G3 fax function for performing G3 fax communication, and a copy function for printing out copied products. To perform such functions, the MFP includes a system control unit 1, a system memory 2, a parameter memory 3, a clock circuit 4, a scanner 5, a plotter 6, an operation display unit 7, an encoding/decoding unit 8, an image storing unit 9, a G3 fax modem 10, and a network control unit (NCU) 11.

The system control unit 1 performs processes for controlling the units of the MFP, procedural steps for controlling a predetermined G3 fax transmission, and processes for controlling a copier, and uses a CPU.

The system memory 2 stores therein control programs executed by the system control unit 1, and various kinds of data required to execute the control programs. The system memory 2 also constitutes a work area of the system control unit 1. The system memory 2 may have a portion, constituted by a read-only memory (ROM), for storing the control programs therein, and the other portions constituted by rewritable memories such as random access memories (RAMs). Alternatively, by constituting a portion for storing therein the programs with a rewritable non-volatile memory such as a flash ROM, the programs may easily be upgraded so as to respond to technological progress.

The parameter memory 3 is a non-volatile memory for storing therein various kinds of information specific to the MFP.

The clock circuit 4 generates and outputs information of current time.

The scanner 5 is an image scanning unit that optically reads an image on an original document with a predetermined resolution. As the scanner 5, an auto document feeder may be used.

The plotter 6 is an image printing unit that prints out (forms), on a sheet with a predetermined resolution, a visible image of image data read by the scanner 5, of received image data, or of image data stored in the system memory 2.

The operation display unit 7 is a unit that displays various operation statuses or setting statuses of the MFP, and on which a user performs various operations and settings and enters information. The operation display unit 7 may include a liquid crystal display of, for example, stacked touch panels, and various operation keys.

The encoding/decoding display section 8 encodes and compresses an image signal (image data), and decodes encoded and compressed image information to an original image signal.

The image storing unit 9 is a memory that stores therein a lot of encoded and compressed image information.

The image storing unit 9 includes a RAM, but may use a high-capacity and rewritable non-volatile memory such as a hard disk device as well.

The G3 fax modem 10 performs modem functions of the G3 fax, and has a low-speed modem function (V.21 modem) for exchanging transmission procedural signals, and high-speed modem functions (V.17 modem, V.34 modem, V.29 modem, V.27 ter modem, etc.) for mainly exchanging image information.

The network control unit 11 connects the MFP to an analog public line, i.e., public switched telephone network (PSTN), and has automatic sending and receiving functions. The network control unit 11 may provide manual access as serving as a telephone.

The system control unit 1, the system memory 2, the parameter memory 3, the clock circuit 4, the scanner 5, the plotter 6, the operation display unit 7, the encoding/decoding unit 8, the image storing unit 9, the G3 fax modem 10, and the network control unit 11 are connected to an internal bus 12. Data exchange among these components is performed mainly via the internal bus 12. Between the network control unit 11 and the G3 fax modem 10, data is exchanged directly.

The system control unit 1 executes the control programs stored in the system memory 2, so as to control operations of the units with information stored in the parameter memory 3. In this way, functions of the present invention are performed, such as functions of an address designating unit, a communicating unit, a result storing unit, a result displaying unit, a control unit, a report output unit, a notifying unit, an authenticating unit, a multi-input enabled/disabled setting unit, an availability setting unit, a history storing unit, a history displaying unit, and an address storing unit.

### Layout of the Operation Display Unit

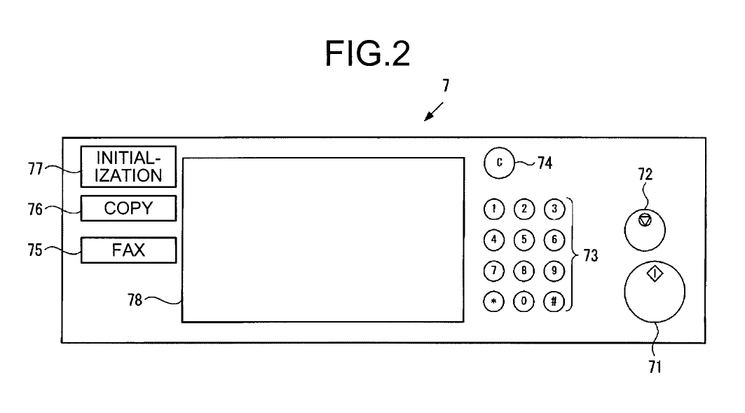

FIG. 2 is a layout drawing of the operation display unit 7 of the MFP shown in FIG. 1. As shown in FIG. 2, the operation display unit 7 includes a start key 71, a stop key 72, numeric keys 73, a clear key 74, a fax key 75, a copy key 76, an initialization key 77, and a liquid crystal display 78.

The start key 71 is used to enter a command of starting sending and receiving operations performed by the MFP.

The stop key 72 is used to enter a command of stopping operations performed by the MFP.

The numeric keys 73 are used to enter numeric information (numeric values) such as telephone numbers.

The clear key 74 is used to cancel telephone numbers or the like entered with the numeric keys 73.

The fax key 75 is used to set an operation mode of the MFP to a facsimile (fax) mode.

The copy key 76 is used to set an operation mode of the MFP to a copy mode.

The initialization key 77 is used to set an operation mode of the MFP to an initialization mode.

The liquid crystal display 78 displays various messages such as operation guidance of the MFP, and feedbacks of input information. The liquid crystal display 78 includes a touch panel for user touch input operation. The user input operation is performed by pressing (touching) buttons of operation items appearing on a screen of the liquid crystal display 78. User touch operations and a touch coordinate are detected by the touch panel, and notified to the system control unit 1.

In the following embodiments, an “address” is indicated by a telephone number for sending a fax. As an address, for example, a mail address for sending a mail, or an Internet protocol (IP) address for sending an IP-fax may also be designated other than telephone numbers and those not for sending a fax. As an address, a recipient may be not only directly designated by a telephone number, a mail address, or the like, but indirectly designated by a name.

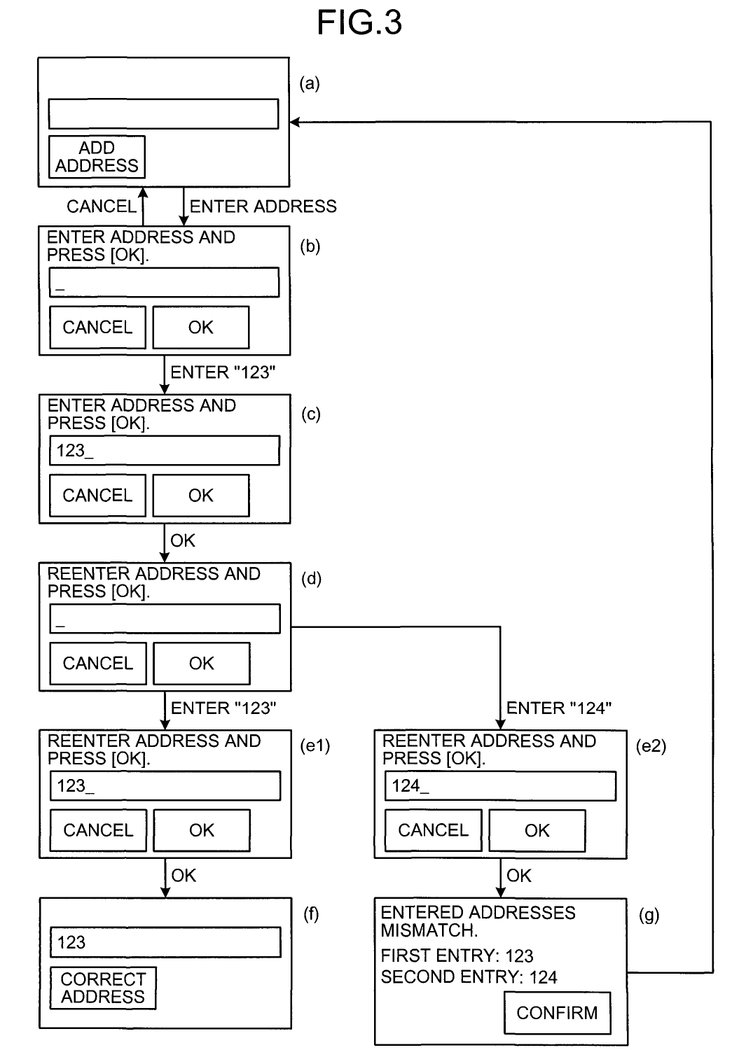

Referring to FIGS. 3 to 29, the following describes embodiments of control processes performed by the MFP according to the present invention.

A first embodiment of the present invention is described below.

FIG. 3 is a screen flow diagram when a telephone number is entered twice using the operation display unit 7 shown in FIG. 2.

FIG. 3 (a) depicts a blank address entry screen on the operation display unit 7 (i.e., the liquid crystal display 78). When “Add address” button is pressed (“Add address” on the screen is touched) by a user, the system control unit 1 of the MFP displays on the operation display unit 7 an address entry screen shown in FIG. 3 (b).

In the address entry screen, a cursor (underbar) is displayed in an address displaying frame (frame above the “Add address” button), indicating that digits of a telephone number can be entered one by one using the numeric keys 73 shown in FIG. 2.

When a telephone number is entered on the address entry screen shown in FIG. 3 (b) with the numeric keys 73, the system control unit 1 of the MFP displays the entered telephone number in the address displaying frame as shown in FIG. 3 (c). By pressing the “OK” button, the address entry screen is cleared, and an address reentry screen appears as shown in FIG. 3 (d). If the same telephone number having been entered first is entered and then an “OK” button shown in FIG. 3 (e1) is pressed, the address reentry screen is cleared to return to the original screen, and the entered telephone number is confirmed (designated) as an address.

With the telephone number confirmed as shown in FIG. 3 (f), pressing the start key 71 shown in FIG. 2 starts transmission (communication operation) to the telephone number (address). The transmission is performed using the G3 fax modem 10 and the network control unit 11.

If a telephone number that is different from the one having been entered first is entered on the address reentry screen shown in FIG. 3 (d) and then an “OK” button shown in FIG. 3 (e2) is pressed, a warning screen indicating a mismatch of the addresses appears as shown in FIG. 3 (g). By pressing the “Confirmation” button, the display screen returns to the screen shown in FIG. 3 (a) where an address is to be entered, discarding the entered telephone number.

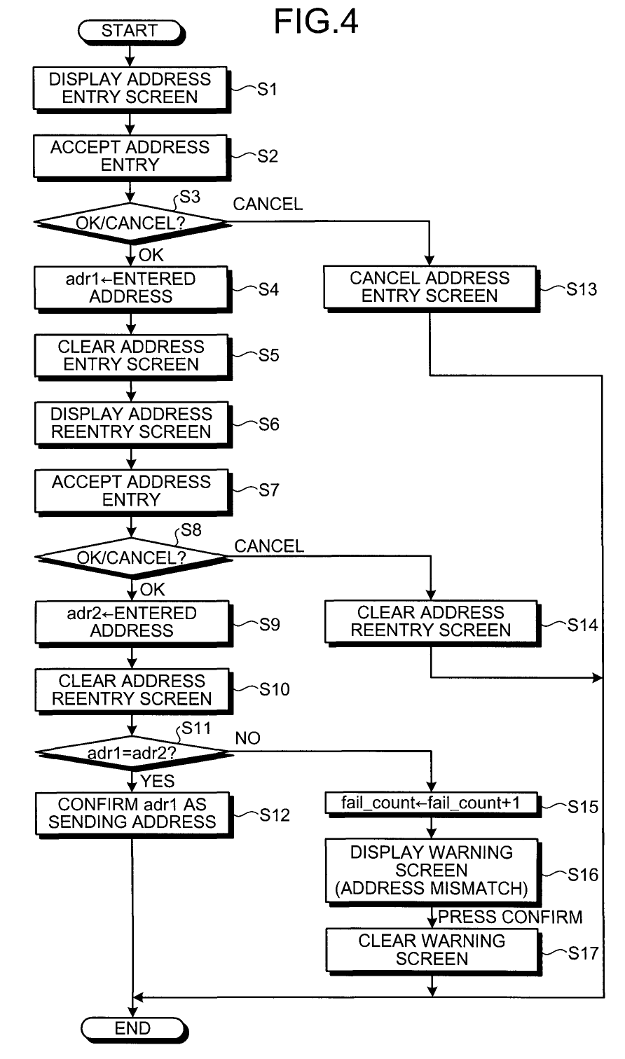

From among the control processes, those not involved in the communication operation are descried in greater detail referring to FIG. 4.

FIG. 4 is a flowchart of a first example of control processes performed by the system control unit 1 of the MFP shown in FIG. 1.

The system control unit 1 of the MFP starts a processing routine shown in FIG. 4 when the “Add address” button on the blank address entry screen shown in FIG. 3 (a) is pressed. The system control unit 1 displays the address entry screen on the operation display unit 7 at Step S1, and waits for a result of “Address entry admission” at Steps S2 and S3.

As the “Address entry admission”, the numeric keys 73 shown in FIG. 2 are pressed, and accordingly corresponding numbers are input. By adding numbers and pressing “OK” or “Cancel”, the admission is terminated.

As a result, if the admission is terminated by “Cancel”, the address entry screen is cleared at Step S13, and the process is terminated (returns to the original screen).

If the admission is terminated by “OK”, the entered address is temporary held as a character string variable adr1 (address character string entered for the first time) at Step S4, and the address entry screen is cleared at Step S5. The address reentry screen then appears on the operation display unit 7 at Step S6, and the user waits for a result of the “address entry admission” again at Steps S7 and S8.

As a result, if the admission is terminated by “Cancel”, the address reentry screen is cleared at Step S14, and the process is terminated (returns to the original screen).

If the admission is terminated by “OK”, the entered address is temporary held as a character string variable adr2 (address character string entered for the second time) at Step S9, and the address reentry screen is cleared at Step S10.

At Step S11, adr1 and adr2 are compared. If adr1 matches adr2, specifically, if an address entered in the first address entry screen matches an address entered in the following address reentry screen, adr1 is confirmed as a sending address at Step S12, and the process is terminated (returns to the original screen). By confirming the address, the confirmed address is displayed in the original screen as shown in FIG. 3 (f).

If adr1 and adr2 do not match, a variable for retaining a failure count of address entry, i.e., fail_count (stored in the parameter memory 3), is incremented by “1” (fail_count+1) at Step S15, and the warning screen indicating the mismatch of the addresses is displayed on the operation display unit 7. In this case, the address is not confirmed. The fail_count is initialized as “0” at the time of installation of the apparatus.

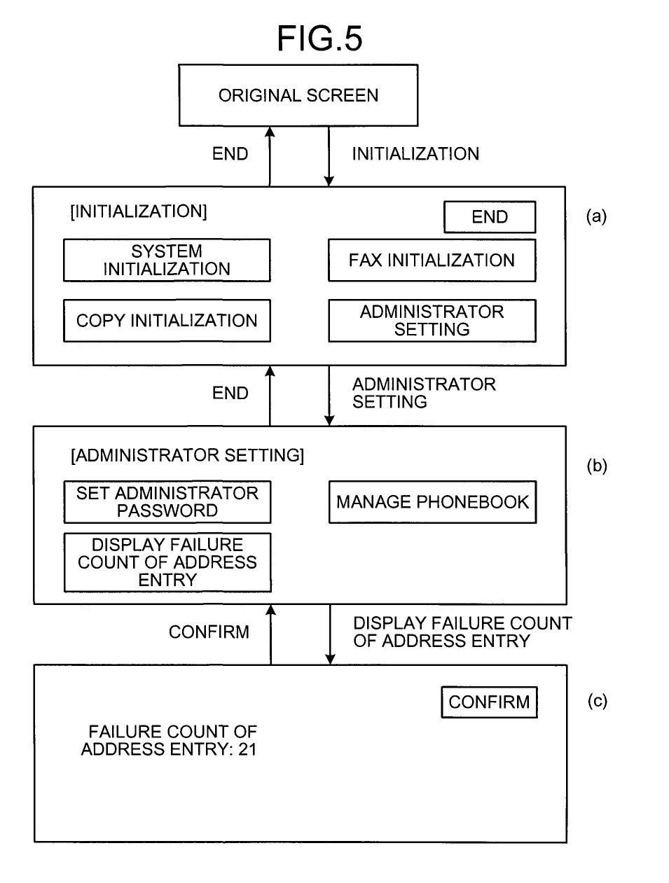

FIG. 5 is a screen flow diagram when the failure count of address entry is viewed using the operation display unit 7 shown in FIG. 2.

When the initialization key 77 on the operation display unit 7 is pressed by a user, the system control unit 1 of the MFP shifts the display screen on the liquid crystal display 78 to an initialization screen shown in FIG. 5 (a). The initialization screen includes “System initialization”, “Copy initialization”, “Fax initialization”, and “Administrator setting” buttons. Pressing the “Administrator setting” shifts the display screen to an administrator setting screen shown in FIG. 5 (b).

On the administrator setting screen, when “Display failure count of address entry” is pressed, a failure count of address entry, which is a failure count of address entry in the MFP, is displayed on the operation display unit 7 to be viewable by the user. The failure count of address entry is equivalent to a value of the fail_count in the processing routine shown in FIG. 4. By arranging such that a password entry is required when the “Administrator setting” or the “Display failure count of address entry” is pressed and that proceeding to the next screen is allowed upon input of a correct password, only a person (administrator) knowing the password can use items of the administrator setting. This arrangement prevents general users not knowing the password from viewing the failure count of address entry.

As such, for address designation, address entry is required twice, and if addresses entered for the first and the second times match, sending operation is performed to the address. Further, if addresses entered for the first and the second times do not match, the result of the mismatch is counted as a failure count of address entry and stored and held in the memory, and the failure count of address entry is displayed to be viewable. This arrangement allows identification of a user having made many address input errors, also allowing a failure count of address entry to be known in each apparatus (MFP). Thus, when the apparatus is used in each department, by checking a failure count of address entry of each apparatus, a department having made many input errors can be identified. By encouraging users and departments having made many address input errors to reduce the errors, address input errors can be reduced.

For address designation, address entry may be required three times or more, and the subsequent control processes may be performed depending on whether addresses entered each time match. The same is applied to the following embodiments.

A second embodiment of the present invention is described below.

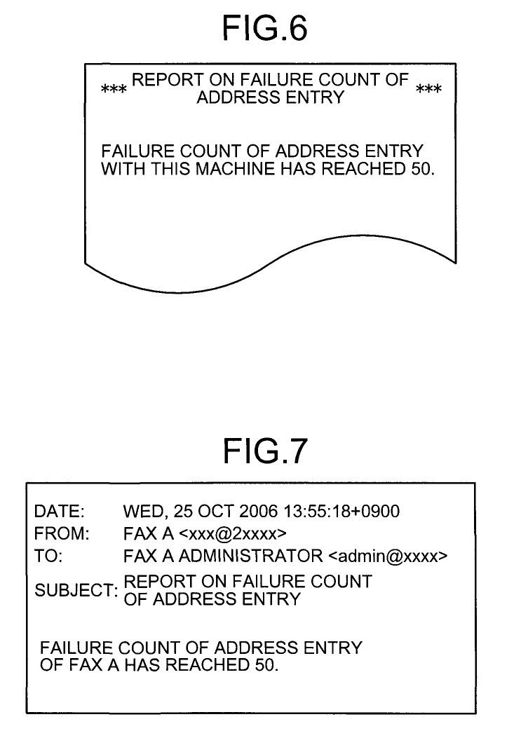

In the second embodiment, the system control unit 1 of the MFP performs the following control processes, in addition to those in the first embodiment. Specifically, when the failure count of address entry reaches a certain count, it is automatically output as a report as shown in FIG. 6 using the plotter 6, or automatically sent (notified) as an electronic mail as shown in FIG. 7 using the G3 fax modem 10 and the network control unit 11.

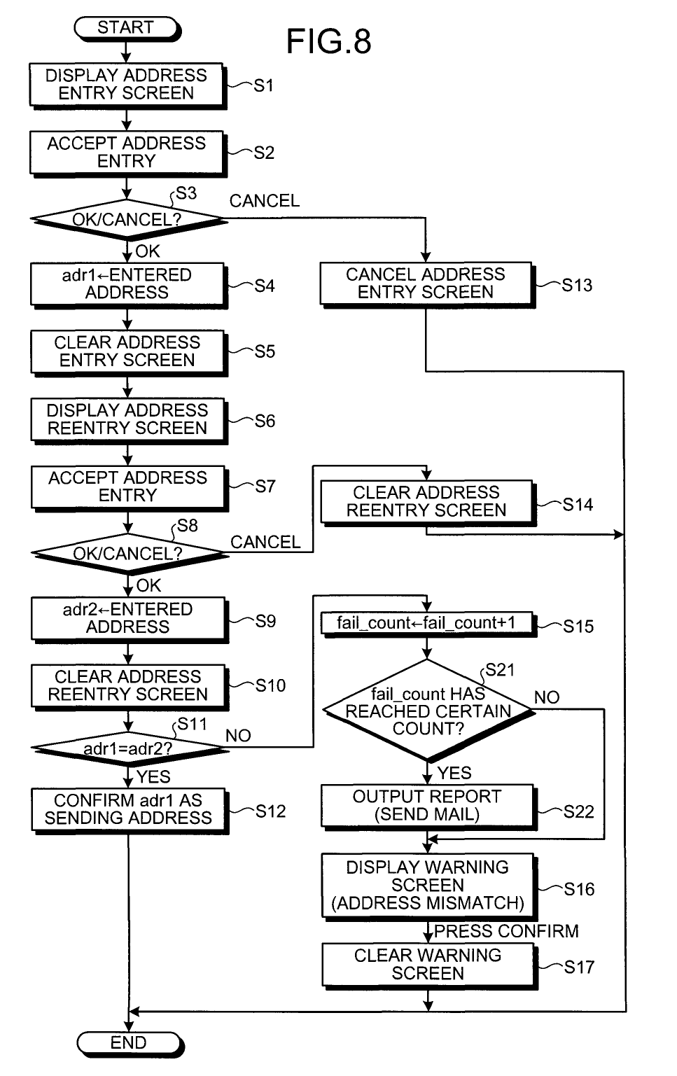

FIG. 8 is a flowchart of a second example of control processes performed by the system control unit 1 of the MFP shown in FIG. 1.

The processing routine differs from the one shown in FIG. 4 in the processes to be performed due to a mismatch of adr1 and adr2 as a result of comparison performed at Step S11. After the fail_count is incremented by “1” at Step S15, if the fail_count reaches a certain count (e.g. fail_count=50), the following processes are performed at Step S22.

Specifically, a report as shown in FIG. 6 is output, or an electronic mail as shown in FIG. 7 is sent to a terminal (computer terminal, portable terminal, etc.) of a previously registered administrator.

The “certain count” does not necessarily be a single count, but can be, for example, “multiples of 50” (in this arrangement, report output or mail delivery is done at counts 50, 100, 150, . . . ).

Both report output and mail delivery may be done for notifying that the failure count of address entry has reached a certain count. Further, both or either one of report output and mail delivery may be done by previously setting as such through manipulation of the operation display unit 7.

When the failure count of address entry (count of a mismatch of addresses) reaches a certain count (when a predetermined condition is met), it is output as a report or notified to a previously set notification recipient. Accordingly, even when an administrator and other personnel do not actively check the failure count of address entry, the output report allows an operator to notice that he or she has made many input errors or an administrator to know that many input errors have occurred with a particular apparatus.

A third embodiment of the present invention is described below.

In the third embodiment, the system control unit 1 of the MFP performs the following control processes, in addition to those in the first and the second embodiments.

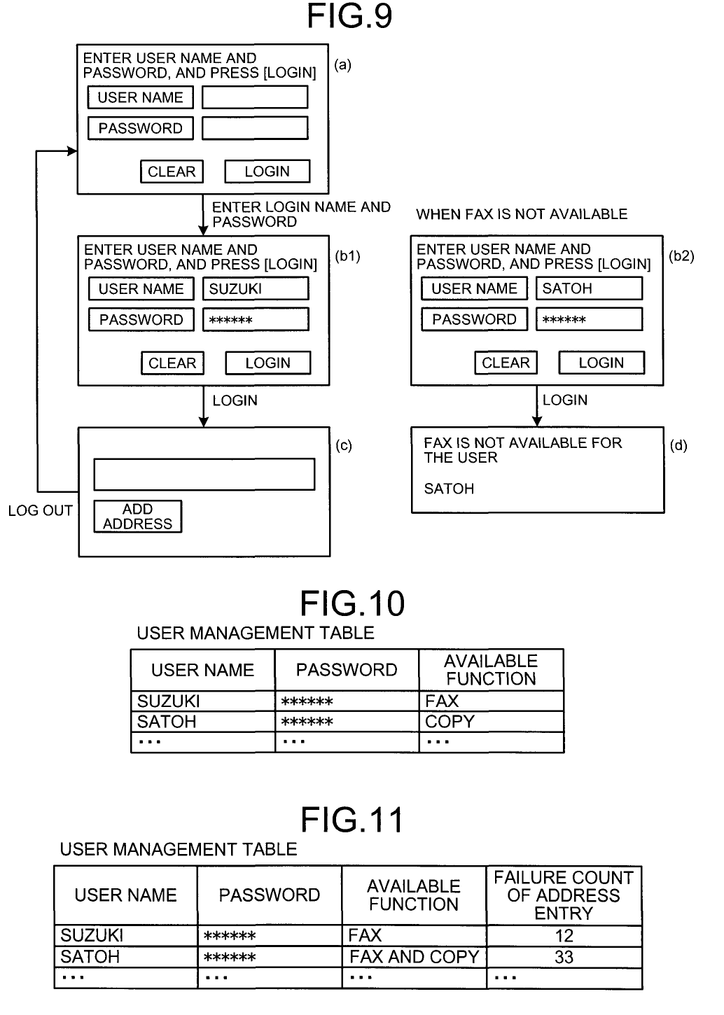

FIG. 9 is a screen flow diagram when operations for user authentication are performed using the operation display unit 7 shown in FIG. 2.

FIG. 10 depicts a first example of a user management table. The user management table is stored and held in the parameter memory 3.

In the third embodiment, when a user uses a function (copy, fax, etc.), the user needs to log in by entering a user name and a password through manipulation of the operation display unit 7. Further, an available function is set for each user.

In FIGS. 9 and 10, for fax use, Mr./Ms. “suzuki” indicated in the user name is allowed to use the fax by logging in. Mr./Ms. “satoh”, however, is not allowed to use the fax and therefore cannot use the fax even by logging in. Logging in is performed by entering a user name and a password, by reading a card to which user information is written as magnetic information, or by other methods.

The following describes a user authentication process performed by the system control unit 1 of the MFP.

When a user attempts to use the MFP (in this example, when the fax key 75 is pressed), the system control unit 1 of the MFP displays on the operation display unit 7 a user authentication screen that requires entry of a user name and a password, which are authentication information (user information) for performing user authentication, as shown in FIG. 9 (a).

Through manipulation of the operation display unit 7, a user name and a password are entered as shown in FIG. 9(b1) or FIG. 9(b2), for example. By pressing the “Login” button, a user authentication request including the user name and the password is issued to the system control unit 1.

Upon receipt of the user authentication request, the system control unit 1 performs user authentication process regarding the authentication information, i.e., the user name and the password, in the user authentication request. Specifically, the system control unit 1 checks whether information matching the authentication information has been registered (stored and held in the user management table).

If information matching the authentication information in the received user authentication request has been registered, the authentication is regarded successful, and a user having entered the authentication information is determined as an authenticated user and logs in. If the user name is “suzuki” as shown in FIG. 10, the user can use the fax and thus the blank address entry screen shown in FIG. 9 (c) is displayed on the operation display unit 7, and the subsequent control processes are performed as in the first and the second embodiments. If the user name is “satoh”, the user cannot use the fax, and thus a warning screen as shown in FIG. 9 (d) is displayed on the operation display unit 7. If information matching the authentication information in the received user authentication request has not been registered, the authentication is regarded unsuccessful, and the display screen on the operation display unit 7 returns to the user authentication screen.

FIG. 11 depicts a second example of the user management table.

With the user management table, a failure count of address entry of each user (user information) can be held. With this user management table, “Failure count of address entry” as information of the current login user (authenticated user) may be incremented by “1” on the user management table, whereas in the processing routine shown in FIG. 4, the fail_count is incremented by “1” at Step S15.

Further, each failure count of address entry is displayed with regard to a failure count of address entry of each user and his or her user name. When report output or mail delivery is performed to notify that the failure count of address entry has reached a certain count, the name of the current login user is also noted.

As such, by counting the failure count of address entry as information of each login user (user information that has been entered when the user is determined as an authenticated user) and then by storing it in the memory, the failure count of address entry is managed for each user who logs in the apparatus, not for each apparatus. With this arrangement, a user having made many address input errors are individually encouraged to reduce the errors.

A fourth embodiment of the present invention is described below.

In the fourth embodiment, the system control unit 1 of the MFP performs the following control processes, in addition to those in the first to the third embodiments.

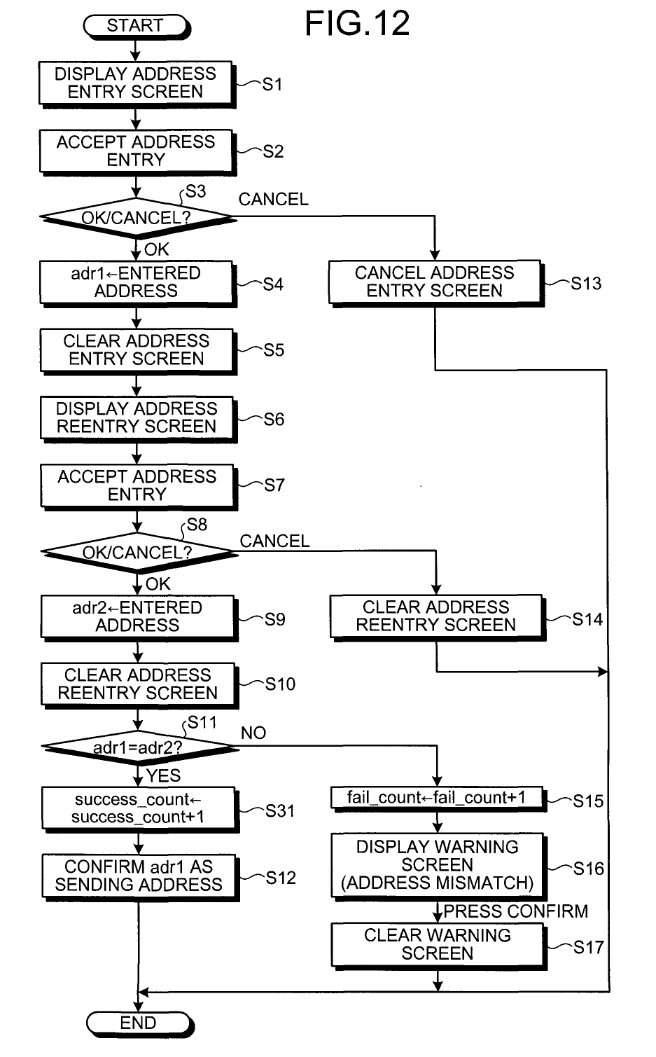

FIG. 12 is a flowchart of a third example of control processes performed by the system control unit 1 of the MFP shown in FIG. 1.

The processing routine differs from the one shown in FIG. 4 in the processes to be performed due to a match of adr1 and adr2 as a result of the comparison performed at Step S11.

The failure count of address entry is held as the fail_count, and also a success count of address entry is held as success_count. Further, if adr1 and adr2 match, the success_count is incremented by “1” at Step S31. The success_count as well as the fail_count are initialized as “0” at the time of installation of the apparatus.

The failure count of address entry may be displayed with regard to the success count of address entry (a value of the success_count) as well. Alternatively, a failure probability (fail_count/(fail_count+success_count)) may also be displayed, for example.

The process at Step S31 shown in FIG. 12 may be inserted between Steps S11 and S12 shown in FIG. 8. Alternatively, by performing the user authentication as in the third embodiment to hold the success count of address entry as well in the user management table shown in FIG. 11, the “success count of address entry” on the user management table as information of the current login user may be incremented by “1”.

With only the failure count of address entry, a user having frequently used the apparatus inevitably reaches a high count. By holding the success count of address entry as well, a department or user having made many address input errors (having reached a high failure probability in address entry) can be identified based on a ratio between the failure count of address entry and the success count of address entry.

A fifth embodiment of the present invention is described below.

In the fifth embodiment, the system control unit 1 of the MFP performs the following control processes, in addition to those (including user authentication) in the fourth embodiment.

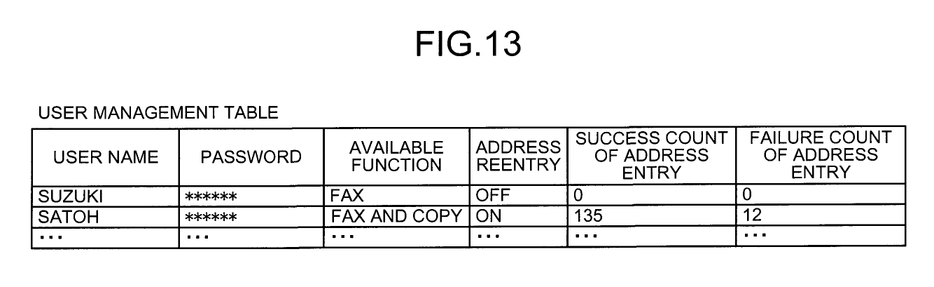

FIG. 13 depicts a third example of the user management table.

In the user management table, when a predetermined condition is met regarding the success count of address entry or the failure count of address entry, for address designation, address reentry (whether address entry is required twice) may be set ON or OFF for each user. Further, a success count of address entry (success_count) and a failure count of address entry (fail_count) of each user may be held.

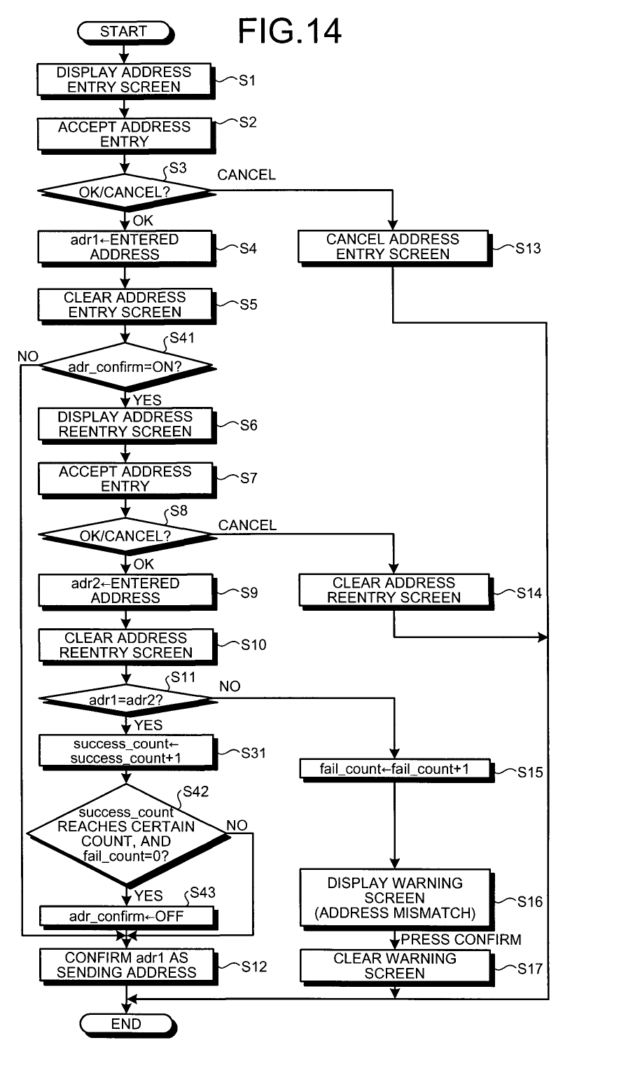

FIG. 14 is a flowchart of a fourth example of control processes performed by the system control unit 1 of the MFP shown in FIG. 1.

The processing routine differs from the one shown in FIG. 12 in that the processes to be performed after the first address entry screen is cleared at Step S5 are different from those to be performed after the success_count is incremented by “1” at Step S31.

After the first address entry screen is cleared at Step S5, checking is performed on whether adr_confirm (address reentry setting for information of the current login user) is set ON or OFF at Step S41. If the adr_confirm is ON, the display screen is switched to the address reentry screen at the subsequent step S6. If the adr_confirm is OFF, a process for confirming adr1 as a sending address is immediately performed at Step S12. Specifically, if the adr_confirm is OFF, the process is complete by entering an address once, without reentering the address.

If adr1 and adr2 match as a result of the comparison at Step S11, the success_count (success count of address entry corresponding to the information of the current login user) is incremented by “1” at Step S31, and then checking is performed at Step S42. When the success_count reaches a certain count (e.g. 30), and also when the fail_count at that time (the failure count of address entry corresponding to the information of the current login user) is “0”, i.e., when address entry is performed successfully a certain number of times with no errors, the adr_confirm is set OFF for the information of the current login user at Step S43 (so that address entry is not performed twice), eliminating the need for the user to reenter the address next time.

As a criterion for setting the adr_confirm OFF, the fail_count is not necessarily be “0”, and may be, for example, equal to or less than 2 against 50 counts of successful address entry. Further, the criterion may be, by holding continuous successful entries of the user instead of the success_count, 30 counts of successful address entry regardless of a count of failed entry in the past. Specifically, if a predetermined condition is met regarding the success count of address entry or the failure count of the address entry, the address reentry is set OFF for the information of the current login user.

As such, when a failure count of address entry (result of a mismatch of addresses) of each user is counted, address entry is not performed twice thereafter by a user whose success count of address entry (result of a match of addresses) has reached a certain count and also whose failure count is “0 (or close to 0)” at that time. This eliminates the need for the user having a low failure probability in address entry to reenter the address, thereby reducing loads of address entry.

A sixth embodiment of the present invention is described below.

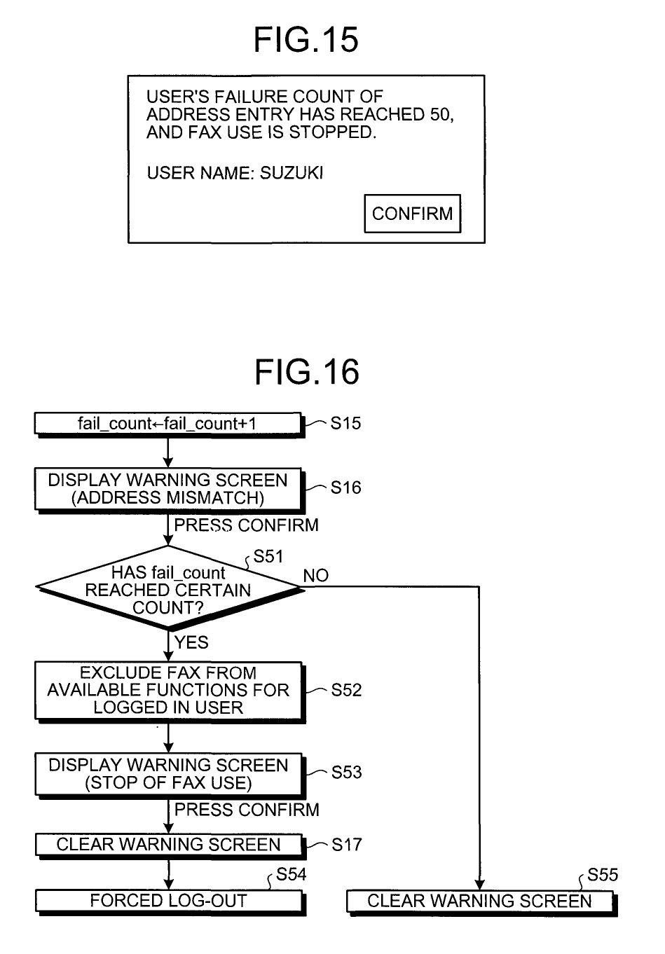

In the sixth embodiment, the system control unit 1 of the MFP performs the following control processes, in addition to those in the third to the fifth embodiments. Specifically, an available apparatus (MFP) or an available function of the apparatus is set for each user. On the user management table (FIG. 11 or FIG. 13), when the failure count of address entry corresponding to the information of the current login user reaches a certain count, use of the fax (or other function/apparatus) may be stopped for the user, and a warning screen notifying stopping the fax use is displayed on the operation display unit 7 as shown in FIG. 15.

FIG. 16 is a flowchart of a fifth example of control processes performed by the system control unit 1 of the MFP shown in FIG. 1.

The processing routine is shown from where the fail_count (failure count of address entry corresponding to the information of the current login user) is incremented by “1” at Step S15 in the processing routine (including user authentication) shown in FIG. 4.

The system control unit 1 of the MFP increments the fail_count by “1” at Step S15, displays the warning screen (mismatch of addresses) at Step S16, and then checks whether the fail_count has reached a certain count (e.g. 50) at Step S51. When the fail_count reaches a certain count, i.e., when address entry is failed a certain number of times, on the user management table, the fax is excluded from the available functions corresponding to the information of the current login user (the fax use is stopped) at Step S52, the warning screen shown in FIG. 15 is displayed on the operation display unit 7 at Step S53, and the user is forced to be logged out at Step S54. Because the fax use is excluded from the available functions for the user on the user management table, the user cannot use the fax even by logging in again.

The processes at Steps S16 and S17 shown in FIG. 8 may be replaced with the processes other than Step S15 shown in FIG. 16. Alternatively, the processes at Steps S15 to S17 shown in FIG. 12 or FIG. 14 may be replaced with the processes shown in FIG. 16.

As such, when the failure count of address entry reaches a certain count, the fax (or other function/apparatus) corresponding to the information of the current login user may be set unavailable, so that the fax use is stopped for a user having a high failure probability in address entry (user having a high risk of sending error). This prevents sending error by a user having made many address input errors.

A seventh embodiment of the present invention is described below.

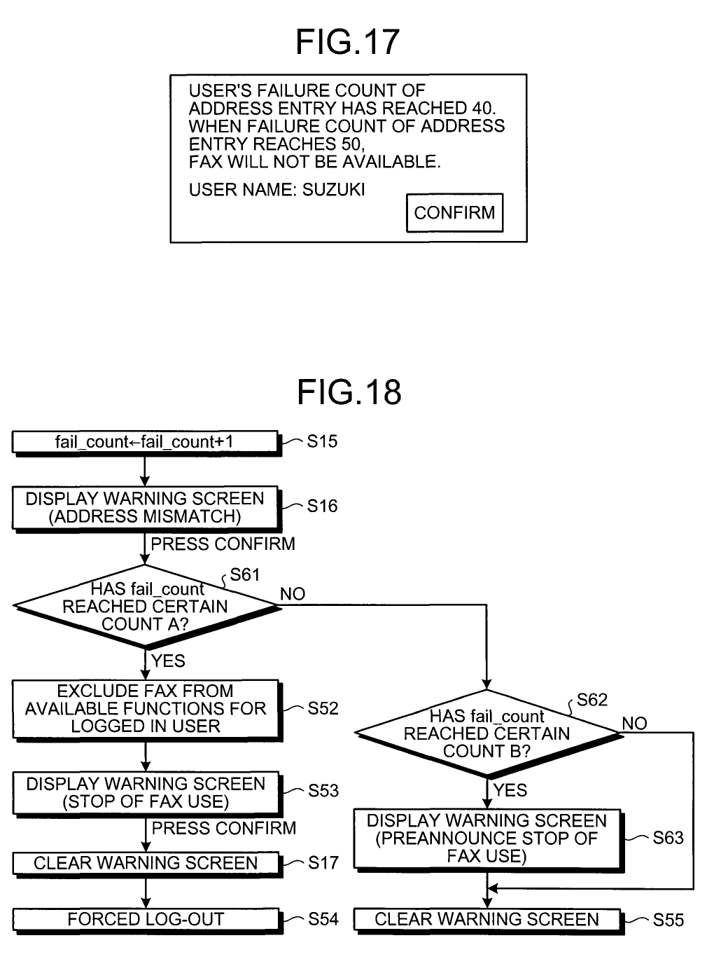

In the seventh embodiment, when the failure count of address entry corresponding to the information of the current login user reaches a certain count before the fax use is stopped as in the sixth embodiment, a warning screen issuing an alert is displayed on the operation display unit 7 as shown in FIG. 17.

FIG. 18 is a flowchart of a sixth example of control processes performed by the system control unit 1 of the MFP shown in FIG. 1.

In the processing routine, a certain count B is less than a certain count A (e.g. B: 40, A: 50).

As in the processing routine shown in FIG. 16, at Step S61, the system control unit 1 of the MFP checks whether the fail_count (failure count of address entry corresponding to the information of the current login user) has reached a certain count A (50 counts). When the fail_count reaches the certain count A, on the user management table, the fax is excluded from the available functions corresponding to the information of the current login user (the fax use is stopped) at Step S52. The processing routine in this embodiment differs with regard to the following points.

Specifically, when the fail_count has not reached a certain count A, checking is performed at Step S62 on whether the fail_count has reached a certain count B (40 counts). When the fail_count has reached the certain count B, a warning screen notifying that the fax use will be unavailable when the failure count of address entry reaches 50 is displayed on the operation display unit 7 as shown in FIG. 17, for example.

As such, a warning (advance notice for stopping the use) notifying that the fax use will be unavailable is displayed (reported) on the operation display unit 7 when the failure count of address entry reaches a certain count B before use of the fax (other function or apparatus) is stopped due to the failure count of address entry reaching a certain count A. In this way, an alert is issued to the user.

An eighth embodiment of the present invention is described below.

In the eighth embodiment, the system control unit 1 of the MFP performs the following control processes, in addition to those in the first to the seventh embodiments.

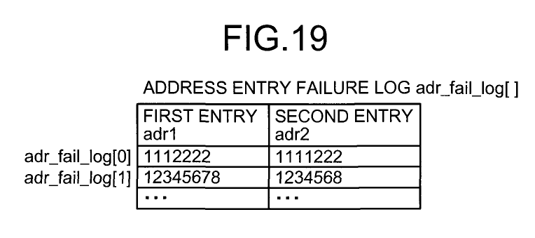

FIG. 19 depicts an address entry failure log adr_fail_log. The address entry failure log adr_fail_log is a pair of contents entered for the first time (contents first entered) and contents entered for the second time (contents reentered), and is stored and held as a log (history) in the parameter memory 3 every time address entry is failed.

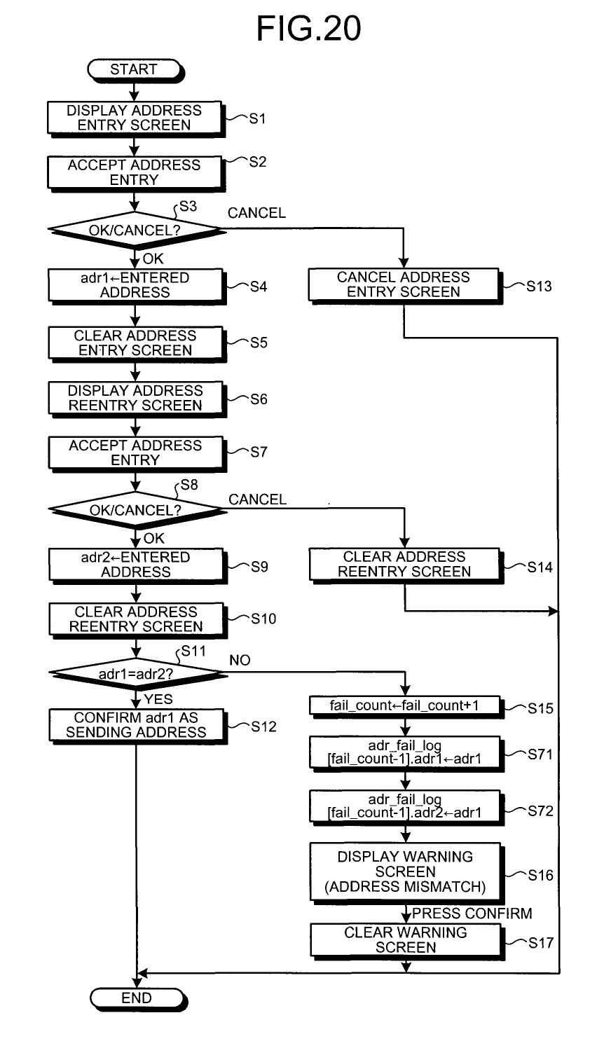

FIG. 20 is a flowchart of a seventh example of control processes performed by the system control unit 1 of the MFP shown in FIG. 1.

In the processing routine, the fail_count is incremented by “1” at Step S15 as in the processing routine shown in FIG. 4, and then contents adr1 entered for the first time and contents adr2 entered for the second time are stored and held in the parameter memory 3 as the address entry failure log adr_fail_log at Steps S71 and S72.

The processes at Steps S71 and S72 shown in FIG. 20 may be inserted between Steps S15 and S21 or between Steps S22 and S16 shown in FIG. 8. Alternatively, the processes at Steps S71 and S72 may be inserted between Steps S15 and S16 shown in FIG. 12, FIG. 14, FIG. 16, or FIG. 18.

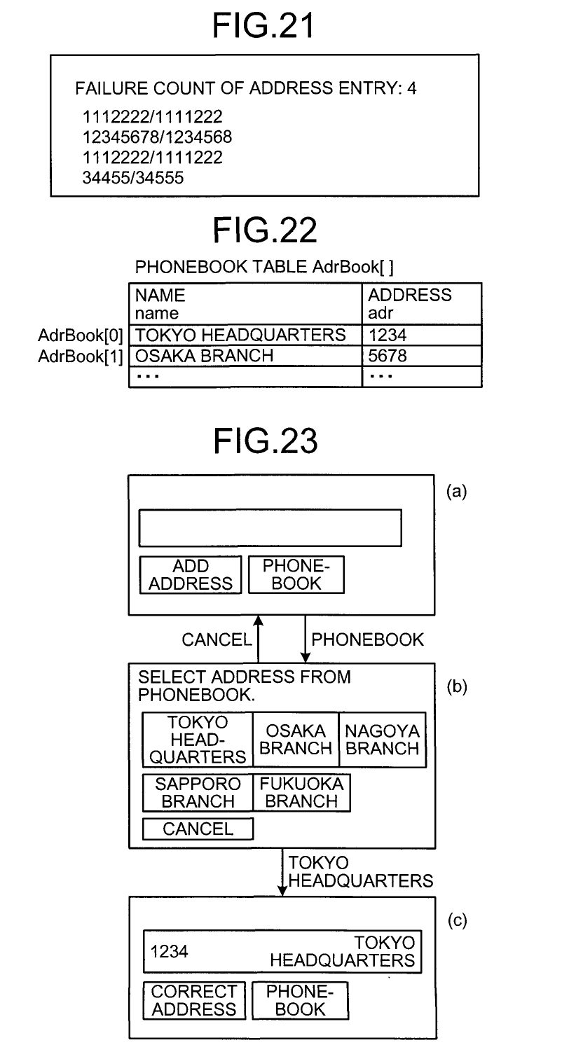

FIG. 21 depicts a display screen that displays contents of address input error on the operation display unit 7 shown in FIG. 2.

The failure count of address entry, and also contents of errors are displayed, such as “contents entered for the first time/contents entered for the second time”. For example, “1112222/1111222” indicates that “1112222” is entered at for the first time and “1111222” is entered for the second time.

As such, if addresses entered for the first and the second times do not match (if address entry is failed), contents entered for the first and the second times are both stored and held in the memory as a log, so that the log can be displayed and viewed. In this way, not only the failure count of address entry, but the tendency of input errors, for example, with what number and how input errors are made can be known.

A ninth embodiment of the present invention is described below.

In the ninth embodiment, the system control unit 1 of the MFP performs the following control processes, in addition to those in the eighth embodiment.

FIG. 22 depicts a phonebook table (hereinafter, also simply referred to as “phonebook”) AdrBook.

In the phonebook table AdrBook, a pair of a name (name) and an address (adr) are stored and held (registered) in the parameter memory 3. With the registration in the phonebook table, a user can designate an address by selecting a name, not a telephone number of a recipient.

FIG. 23 is a screen flow diagram when an address registered in the phonebook table is designated using the operation display unit 7 shown in FIG. 2.

FIG. 23 (a) depicts a blank address entry screen on the operation display unit 7 (i.e., the liquid crystal display 78). When “Phonebook” is pressed by a user, the system control unit 1 of the MFP displays on the operation display unit 7 a phonebook screen for selecting an address from the phonebook table as shown in FIG. 23 (b) for example. By selecting (pressing) an address “Tokyo headquarters”, the selected address is confirmed (designated) as shown in FIG. 23 (c) for example.

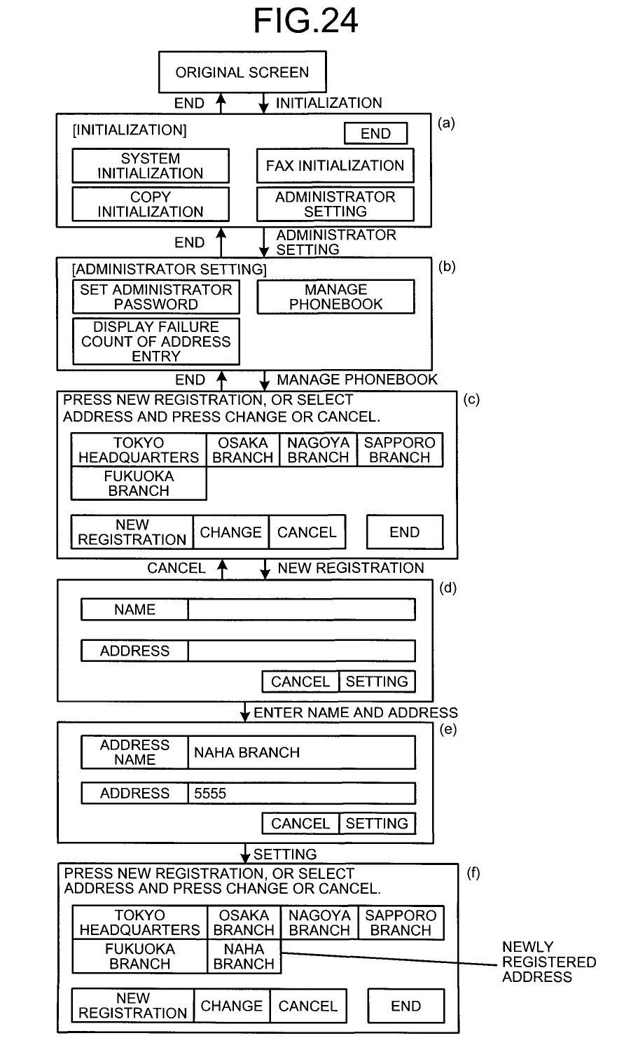

FIG. 24 is a screen flow diagram when an address is registered in the phonebook table using the operation display unit 7 shown in FIG. 2.

When “Phonebook management” on an administrator setting screen shown in FIG. 24 (b) (same in FIG. 5 (b)) is pressed, the system control unit 1 of the MFP displays a screen shown in FIG. 24 (c) for example. By pressing “New registration”, an entry screen for a name and an address is displayed as shown in FIG. 24 (d) for example. Further, by entering a name and an address as shown in FIG. 24 (e) and then pressing “Setting”, the entered address (i.e., the address name and the telephone number) is newly registered in the phonebook table as shown in FIG. 24 (f) for example.

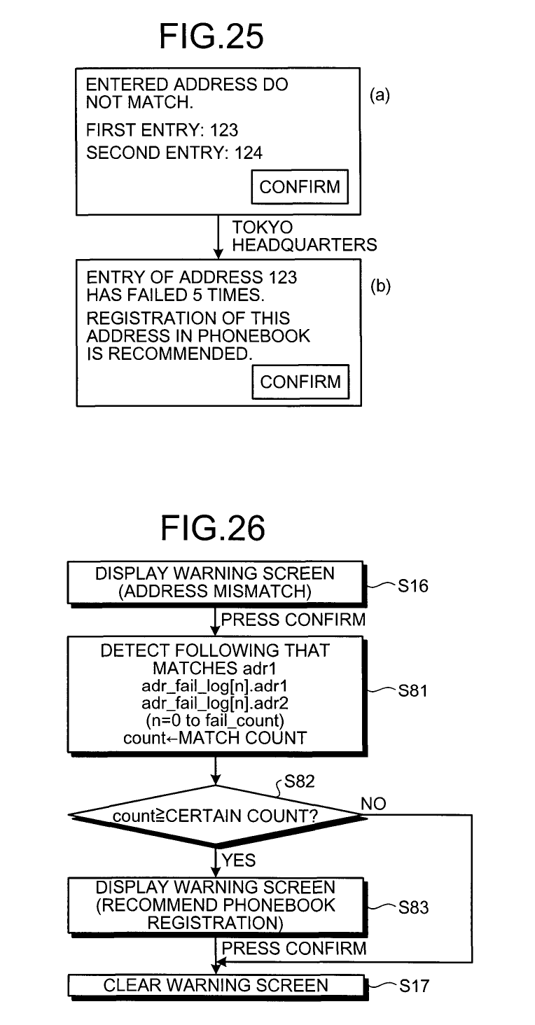

FIG. 25 is a simplified flow screen diagram for recommending phonebook registration when address entry is failed.

If address entry is failed (addresses entered for the first and the second times do not match), and also if the address appears on the address entry failure log a certain number of times (if input errors have been made with the same address in the past), the system control unit 1 of the MFP displays a warning screen that recommends registration in the phonebook table.

FIG. 26 is a flowchart of an eighth example of control processes performed by the system control unit 1 of the MFP shown in FIG. 1.

The processing routine is shown from where the warning screen (mismatch of addresses) is displayed at Step S16 in the processing routine shown in FIG. 20.

The system control unit 1 of the MFP detects at Step S81 a count of how many times contents adr1 entered for the first time has been recorded on the address entry failure log, and checks at Step S82 whether the count (count) is equal to or greater than a certain count. If the count is equal to or greater than a certain count, the system control unit 1 of the MFP displays at Step S83 a warning screen as shown in FIG. 25 (b).

The processes at Steps S81 to S83 shown in FIG. 26 may be performed similarly on contents adr2 entered for the second time, not on the contents adr1 entered for the first time. Although the processes at Steps S81 to S83 are performed when address entry is failed in the processing routine shown in FIG. 26, the processes may be performed when address entry is successful.

As such, if a predetermined condition is met regarding contents of a registered log and addresses entered for the first and the second times for address designation (if an address entered with failed address entry has been recorded on the log a certain number of times or more), recommendation for storing the address in the phonebook (memory) may be displayed (reported). This arrangement encourages a user to register in the phonebook an address that is often entered erroneously. As a result, an address can be designated from the phonebook, preventing sending error due to address input error.

A tenth embodiment of the present invention is described below.

In the tenth embodiment, the system control unit 1 of the MFP performs the following control processes, in addition to those in the eighth embodiment.

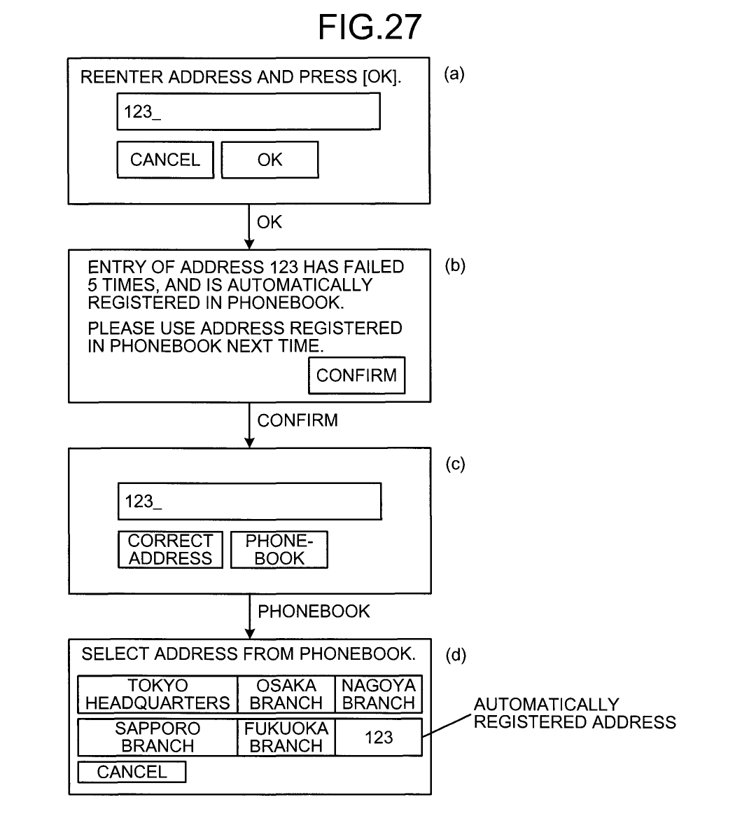

FIG. 27 is a screen flow diagram when an address is automatically registered in the phonebook table (see FIG. 22) using the operation display unit 7 shown in FIG. 2.

FIG. 27 (a) depicts an address reentry screen (that appears by performing the steps described referring to FIG. 3) on the operation display unit 7. When an address (entered for the first time) is correctly entered for the second time and “OK” is pressed by a user, the system control unit 1 of the MFP confirms the address entered as shown in FIG. 27 (c). Before the confirmation, if the address appears on the address entry failure log a certain number of times or more (if input errors have been made with the address in the past), the address is automatically registered in the phonebook table, and a registration confirmation screen for recommending the confirmation is displayed as shown in FIG. 27 (b).

Then when “Confirmation” on the registration confirmation screen is pressed, the address entered as shown in FIG. 27 (c) is confirmed as a sending address. By pressing “Phonebook”, a phonebook screen including the address having been automatically registered in the phonebook table is displayed on the operation display unit 7 as shown in FIG. 27 (d).

As such, the entered address is automatically registered, allowing a selection from the phonebook table.

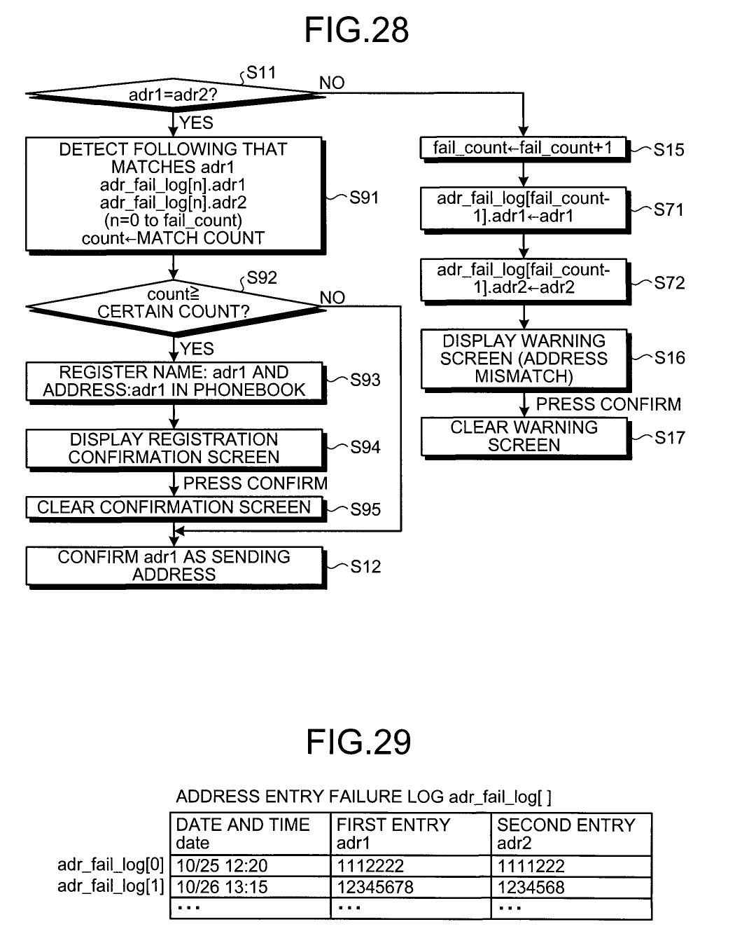

FIG. 28 is a flowchart of a ninth example of control processes performed by the system control unit 1 of the MFP shown in FIG. 1.

The processing routine is shown from where checking is performed at Step S11 on whether adr1 and adr2 match in the processing routine shown in FIG. 20.

If adr1 and adr2 match, the system control unit 1 of the MFP detects at Step S91 a count of how many times the entered address adr1 has been recorded on the address entry failure log, and performs checking at Step S92 on whether the count (count) is equal to or greater than a certain count.

If the entered address adr1 has been recorded on the address entry failure log a certain number of times or more (count), the entered address is registered (stored and held) in the phonebook table at Step S93. Then at Step S94, the registration confirmation screen as shown in FIG. 27 (b) is displayed to notify the user that the address has been automatically registered. For address registration in the phonebook table, although the address (telephone number) is set both as a name and an address at Step S93 shown in FIG. 28, the user may be required to enter a specific name.

Then when “Confirmation” is pressed on the registration confirmation screen, the registration confirmation screen is cleared at Step S95, and the entered address is confirmed as a sending address at Step S12.

If adr1 and adr2 do not match, processes subsequent to Step S15 are performed as described referring to FIG. 20.

Although the address registration is performed with successful address entry, it may be performed with failed address entry. When registering an address with failed address entry, it is unknown which of the addresses entered for the first and the second times is correct. Thus, the user should confirm a correct address before registering the address.

As such, if a predetermined condition is met regarding contents of a registered log and addresses entered for the first and the second times for address designation (if an address entered with successful address entry has been recorded on the log a certain number of times or more), a correct address is automatically registered on the phonebook. This arrangement allows a user to designate from the phonebook an address that is often entered erroneously. As a result, an address can be designated from the phonebook, preventing sending error due to address input error.

An eleventh embodiment of the present invention is described below.

The eleventh embodiment slightly differs from any of the eighth to tenth embodiments.

FIG. 29 depicts another arrangement of the address entry failure log adr_fail_log. The address entry failure log adr_fail_log is a set of contents entered for the first time (contents first entered), contents entered for the second time (contents reentered), and a date and a time of each entry, and is store and held as a log in the parameter memory 3 every time address entry is failed.

Specifically, in the eleventh embodiment, when address entry is failed, contents entered for the first and the second times together with dates and times of those entries are stored as a log.

As such, a date and a time of a failed address entry are stored to be displayed and viewed. This allows a user to know a date of the week or a time of day when address input errors are made more likely, for example, “input errors are made more likely on Friday evenings”.

The foregoing describes embodiments applied to a digital multifunction product (MFP) having communication functions according to the present invention. The present invention is not limited to this, and may be applied to various electronic apparatuses such as digital copiers, facsimile apparatuses, printers, and other image forming apparatuses, all having communication functions, and also image scanning apparatuses (scanners, etc.), mail terminals, telephones, and computers.

A program according to the embodiments enables a computer (CPU) that controls an electronic apparatus to perform functions according to the present invention, such as an address designating unit, a communicating unit, a result storing unit, a result displaying unit, a control unit, a report output unit, a notifying unit, an authenticating unit, a multi-input enabled/disabled setting unit, an availability setting unit, a history storing unit, a history displaying unit, and an address storing unit. By causing a computer to perform such functions, the above-described advantages can be achieved.

The program may be stored in a storing unit such as a ROM or a hard disk device (HDD) in advance. The program may also be provided as being recorded to a recording medium (memory) that is a non-volatile recording medium such as a compact disk read only memory (CD-ROM), a flexible disk, a static random access memory (SPAM), an electronically erasable and programmable read only memory (EEPROM), or a memory card. The above-described steps can be performed by causing a computer to execute the program recorded to such a memory, or by causing a computer to read out the program from the memory to execute it.

The steps can also be performed by downloading the program from an external device coupled to a network and including a recording medium storing the program therein, or from an external device coupled to a network and storing the program in a recording medium thereof.

As described above, according to an aspect of the present invention, an electronic apparatus includes an address designating unit that designates an address, a communicating unit that performs communication to an address designated by the address designating unit, a result storing unit that stores a result therein, a result displaying unit that displays a result, stored by the result storing unit, to be viewable, and a control unit. The control unit causes the address designating unit to perform address entry more than one time for address designation, and causes the communicating unit to perform communication to a matched address thus entered, or the result storing unit to store therein a result of a mismatch of entered addresses so that the result can be displayed to be viewable. This arrangement allows a user having made many address input errors to be encouraged to reduce the errors, or facilitates investigation on the tendency of address input errors, enabling to reduce address input errors.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic apparatus comprising:
an address designating unit that designates a destination address;
a communicating unit that performs a communication operation to the destination address designated by the address designating unit;
a result storing unit that stores therein a result of an operation;
a result displaying unit that displays the result, stored in the result storing unit in a readable manner; and
a control unit that, upon the address designating unit designating the destination address, with a plurality of inputs of the destination address, causes the communicating unit to perform a communication to the destination address when the destination address is identical at each of the inputs, and causes the result storing unit to store therein a result of an address mismatch when the destination address is not identical at each of the inputs.

2. The electronic apparatus according to claim 1, further comprising an output unit that outputs a report when the result of the address mismatch stored in the result storing unit meets a predetermined condition.

3. The electronic apparatus according to claim 1, further comprising a notifying unit that sends a notification to a preset notification destination when the result of the address mismatch stored in the result storing unit meets a predetermined condition.

4. The electronic apparatus according to claim 1, wherein the control unit includes a storing unit that stores a result of an address match in the result storing unit when the destination address is identical at each of the inputs.

5. The electronic apparatus according to claim 1, further comprising an authenticating unit that determines a user having entered user information that matches pre-registered user information as an authenticated user, wherein
the control unit causes the result storing unit to store therein the result of the address mismatch in association with the user information that is entered when the user is determined to be an authenticated user by the authenticating unit.

6. The electronic apparatus according to claim 5, wherein the control unit includes a storing unit that stores a result of an address match in association with the user information that is entered when the user is determined to be an authenticated user by the authenticating unit, when the destination address is identical at each of the inputs.

7. The electronic apparatus according to claim 6, further comprising a multiple-input setting unit that sets whether to cause a plurality of inputs of the destination address to be performed for each authenticated user when performing a designation of the destination address, wherein
the control unit includes a setting unit that causes the multiple-input setting unit to set to perform a single time of input of the destination address for the authenticated user if either one of the result of the address match and the result of the address mismatch meets a predetermined condition.

8. The electronic apparatus according to claim 5, further comprising a usage setting unit that sets availability of either one of the electronic apparatus and a function of the electronic apparatus for each authenticated user, wherein
the control unit includes a setting unit that causes the usage setting unit to set a usage of either one of the electronic apparatus and the function of the electronic apparatus to be disabled for the authenticated user if the result of the address mismatch meets a predetermined condition.

9. The electronic apparatus according to claim 8, wherein the control unit includes a notifying unit that notifies the authenticated user of disabling of the usage of either one of the electronic apparatus and the function of the electronic apparatus if the result of the address mismatch meets a condition other than the predetermined condition.

10. The electronic apparatus according to claim 1, further comprising:
a history storing unit that stores therein a history of an operation; and
a history displaying unit that displays the history stored by the history storing unit in a readable manner, wherein
the control unit includes a storing unit that stores contents of an input at each of the inputs in the history storing unit as the history, when the destination address is not identical at each of the inputs.

11. The electronic apparatus according to claim 10, further comprising an address storing unit that stores therein an address, wherein
the address designating unit includes a designating unit that designates the destination address using the address stored in the address storing unit, and
the control unit includes a prompting unit that prompts the address storing unit to store therein the address if a predetermined condition is met regarding contents of the history stored in the history storing unit and the destination addresses input at each of the inputs.

12. The electronic apparatus according to claim 10, further comprising an address storing unit that stores therein an address, wherein
the address designating unit includes a designating unit that designates the destination address using the address stored in the address storing unit, and
the control unit includes a storing unit that stores the address in the address storing unit if a predetermined condition is met regarding contents of the history stored in the history storing unit and the destination addresses input at each of the inputs.

13. The electronic apparatus according to claim 10, wherein when storing the contents of the input at each of the inputs in the history storing unit as the history, the control unit associates a date and time with the contents of the input.

14. A method of controlling an electronic apparatus that performs a communication to a destination address that is designated in advance, the method comprising:
causing a plurality of inputs of the destination address to be performed; and
causing a communication to the destination address to be performed when the destination address is identical at each of the inputs, and causing a result of an address mismatch to be stored in a memory when the destination address is not identical at each of the inputs.

15. A computer program product comprising a computer-usable medium having computer-readable program codes embodied in the medium that when executed cause a computer to execute:
causing a plurality of inputs of the destination address to be performed; and
causing a communication to the destination address to be performed when the destination address is identical at each of the inputs, and causing a result of an address mismatch to be stored in a memory when the destination address is not identical at each of the inputs.

16. The computer program product according to claim 15, wherein the program codes further cause the computer to execute outputting a notification when the result of the address mismatch meets a predetermined condition.
